(19) United States
(12) Patent Application Publication
(10) Pub. No.: US 2024/0430835 A1
(43) Pub. Date: Dec. 26, 2024

(54) TERMINAL AND COMMUNICATION METHOD

(71) Applicant: NTT DOCOMO, INC., Tokyo (JP)

(72) Inventors: Shohei Yoshioka, Chiyoda-ku, Tokyo (JP); Daisuke Kurita, Chiyoda-ku, Tokyo (JP); Hiroki Harada, Chiyoda-ku, Tokyo (JP); Satoshi Nagata, Chiyoda-ku, Tokyo (JP); Wenjia Liu, Beijing (CN); Jing Wang, Beijing (CN); Lan Chen, Beijing (CN)

(73) Assignee: NTT DOCOMO, INC., Tokyo (JP)

(21) Appl. No.: 18/703,959

(22) PCT Filed: Nov. 4, 2021
(86) PCT No.: PCT/JP2021/040683

§ 371 Date: Apr. 23, 2024

(51) Int. Cl. H04W 56/00; H04W 74/0833; H04W 84/06

(52) U.S. Cl. CPC H04W 56/0045; H04W 74/0833; H04W 84/06

(57) ABSTRACT

A terminal that performs a communication with a base station via a satellite or a flying object, includes a reception unit configured to receive from the base station, during the communication with the base station, information indicating a type of a non-terrestrial network, and a control unit configured to perform a control based on the type of the non-terrestrial network.

### TECHNICAL FIELD

The present invention relates to terminals and communication methods in wireless communication systems.

### BACKGROUND ART

In the NR (New Radio) (also referred to as the “5G”), or successor system to the LTE (Long Term Evolution), technologies satisfying requirements such as high capacity system, high data transmission rate, low delay, simultaneous connection of multiple terminals, low cost, power saving, and the like are being studied (for example, Non-Patent Document 1).

Currently, the NTN (Non-Terrestrial Network) is also being studied. The NTN provides services to an area that cannot be covered by a terrestrial 5G network mainly due to the cost aspect, by using a non-terrestrial network such as an artificial satellite (hereinafter, referred to as a satellite).

In the NR release 17, a technique for performing time synchronization or frequency synchronization based on the satellite orbit is being studied. For example, a terminal shares satellite orbit data from a base station. The terminal can calculate a value indicating a timing advance for a service link and can perform a pre-compensation or a post-compensation of the Doppler shift for frequency compensation, based on the satellite orbit data and on position information acquired by the GNSS (Global Navigation Satellite System).

The common TA and the terminal-specific TA are defined. The terminal updates the common TA, based on a parameter of the common TA received from the base station, and updates the terminal-specific TA, based on a satellite orbit parameter received from the base station. The terminal is required to recognize a reference time of broadcast parameters, in order to easily estimate the common TA and the terminal-specific TA at a given time point within one valid period. Hence, the reference time of the satellite orbit parameters is defined.

### PRIOR ART DOCUMENTS

### Non-Patent Documents

Non-Patent Document 1: 3GPP TS 38.300 V16.6.0 (2021 June)

### DISCLOSURE OF THE INVENTION

### Problem to be Solved by the Invention

Considering the different propagation delays depending on the different NTN types, different designs are required for timing-related parameters. In addition, in order to enable the terminal to recognize ranges and the like of the values, the NTN type needs to be specified. However, there is a problem in that a definition of the NTN type and a method of specifying the NTN type are conventionally not stipulated.

The present invention was conceived in view of the foregoing, and one object of the present invention is to enable a type of the non-terrestrial network to be indicated.

### Means of Solving the Problem

According to the disclosed technique, a terminal that performs a communication with a base station via a satellite or a flying object, includes a reception unit configured to receive from the base station, during the communication with the base station, information indicating a type of a non-terrestrial network, and a control unit configured to perform a control based on the type of the non-terrestrial network.

### Effects of Invention

According to the disclosed technique, a technology is provided that enables the type of the non-terrestrial network to be indicated.

### BRIEF DESCRIPTION OF THE DRAWINGS

FIG. 1 is a first drawing for describing a non-terrestrial network.

FIG. 2 is a second drawing for describing the non-terrestrial network.

FIG. 3 is a third drawing for describing the non-terrestrial network.

FIG. 4 is a fourth drawing for describing the non-terrestrial network.

FIG. 5 is a drawing for describing an enhancement of a timing advance.

FIG. 6 is a flow chart illustrating an example of a calculation flow of the timing advance.

FIG. 7 is a drawing for describing types of the non-terrestrial network.

FIG. 8 is a drawing for describing features of each type of the non-terrestrial network.

FIG. 9 is a drawing illustrating an example of a functional structure of a base station in an embodiment of the present invention.

FIG. 10 is a drawing illustrating an example of a functional structure of a terminal in an embodiment of the present invention.

FIG. 11 is a drawing illustrating an example of a hardware structure of the base station or the terminal in an embodiment of the present invention.

FIG. 12 is a drawing illustrating an example of a structure of a vehicle in an embodiment of the present invention.

### MODE OF CARRYING OUT THE INVENTION

In the following, embodiments of the present invention will be described with reference to the drawings. The embodiments described in the following are examples, and embodiments to which the present invention may be applied are not limited to the following embodiments.

During operation of a wireless communication system according to an embodiment of the present invention, existing techniques may be used, as appropriate. The existing techniques include, but are not limited to, the conventional NR or LTE, for example. Further, it is assumed that the term “LTE” used in the present specification has a broad meaning including a scheme of LTE-Advanced and schemes after the LTE-Advanced (for example, NR), unless indicated otherwise.

Furthermore, in the embodiments described in the following, terms that are used in the existing LTE, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), and the like, are used. These terms are used for the sake of convenience. Signals, functions, and the like, which are similar to these terms, may be referred to by other names. Moreover, the terms noted above that are used in NR correspond to NR-SS, NR-PSS, NR-SSS, NR-PBCH, NR-PRACH, and the like. However, even in the case of the signals used in NR, the signals are not necessarily referred to as “NR-”.

In addition, in an embodiment of the present invention, a duplex system may be a TDD (Time Division Duplex) system, an FDD (Frequency Division Duplex) system, or other systems (for example. Flexible Duplex, and the like).

Further, in an embodiment of the present invention, “to configure” a radio parameter and the like may refer to pre-configuring the radio parameter to a predetermined value, or refer to configuring the radio parameter to a radio parameter indicated from the base station or the terminal.

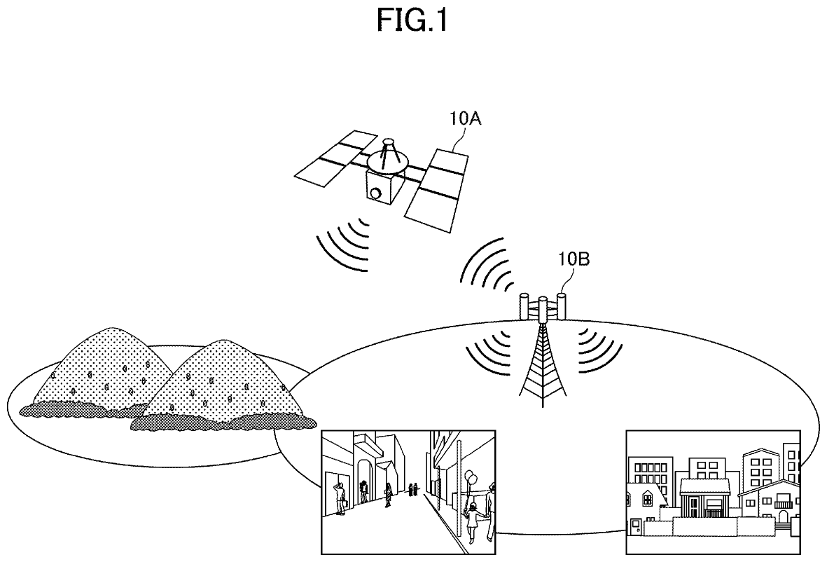

FIG. 1 is a first drawing for describing a non-terrestrial network. The Non-Terrestrial Network (NTN) provides services to an area that cannot be covered by a terrestrial 5G network mainly due to the cost aspect, by using a non-terrestrial device such as a satellite and the like. Moreover, services with a higher reliability may be provided by the NTN. For example, it is assumed that the NTN is applied to IoT (Internet of Things), ships, buses, trains, or critical communications. Further, the NTN has scalability according to efficient multi cast or broadcast.

As an example of the NTN, a satellite 10A can provide services in an area in which a terrestrial base station is not provided, such as in a mountainous area and the like, for example, by retransmitting a signal transmitted from a terrestrial base station 10B, as illustrated in FIG. 1.

The terrestrial 5G network may have a structure described in the following. The terrestrial 5G network may include one or more base stations 10 and one or more terminals 20. The base station 10 is a communication device that provides one or more cells and performs a wireless communication with the terminal 20. Physical resources of a radio signal may be defined in a time domain and a frequency domain, the time domain may be defined by a number of OFDM symbols, and the frequency domain may be defined by a number of sub-carriers or a number of resource blocks. The base station 10 transmits a synchronization signal and system information to the terminal 20. The synchronization signal is the NR-PSS and the NR-SSS, for example, The system information is transmitted via the NR-PBCH, for example, and may be referred to as broadcast information.

The base station 10 transmits a control signal or data to the terminal 20 via a DL (Downlink), and receives a control signal or data from the terminal 20 via a UL (Uplink). Each of the base station 10 and terminal 20 is capable of transmitting and receiving signals by performing a beamforming. In addition, each of the base station 10 and the terminal 20 can apply an MIMO (Multiple Input Multiple Output) communication to the DL or the UL. Further, each of the base station 10 and terminal 20 may perform the communications via an SCell (Secondary Cell) and a PCell (Primary Cell) using CA (Carrier Aggregation).

The terminal 20 may be a communication apparatus that includes a wireless communication function, such as a smartphone, a mobile phone, a tablet, a wearable terminal, a communication module for M2M (Machine-to-Machine), and the like. The terminal 20 utilizes various communication services provided by the wireless communication system, by receiving the control signal or data from the base station 10 via the DL and transmitting the control signal or data to the base station 10 via the UL.

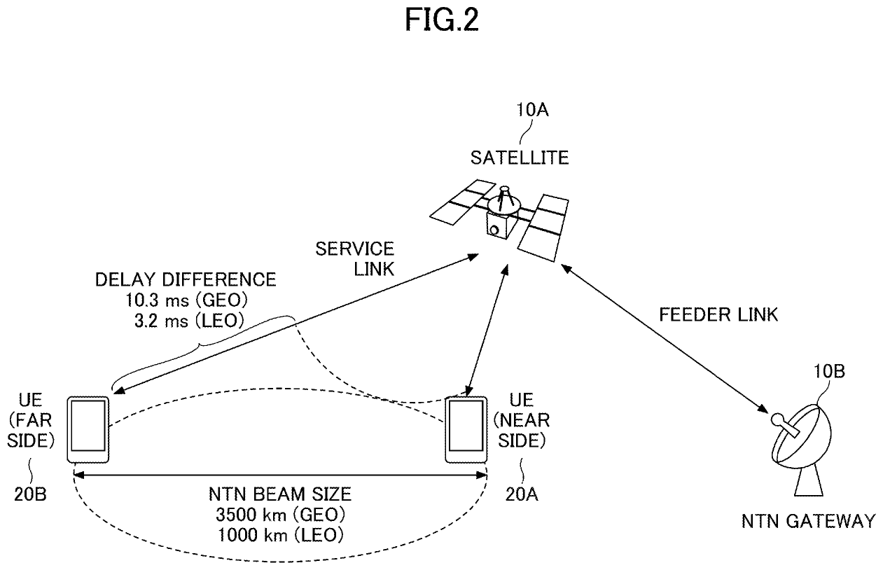

FIG. 2 is a second drawing for describing the non-terrestrial network. In the NTN, a cell or an area for each beam is very large when compared with the terrestrial network (TN). FIG. 2 illustrates an example of the NTN configured by retransmissions using the satellite. A connection between the satellite 10A and an NTN gateway 10B is referred to as a feeder link, and a connection between the satellite 10A and a UE 20 is referred to as a service link.

As illustrated in FIG. 2, a delay difference between a near side UE 20A and a far side UE 20B is 10.3 ms in the case of GEO (Geosynchronous orbit), and 3.2 ms in the case of LEO (Low Earth orbit), for example. Further, the beam size in the NTN is 3500 km in the case of GEO, and 1000 km in the case of LEO, for example.

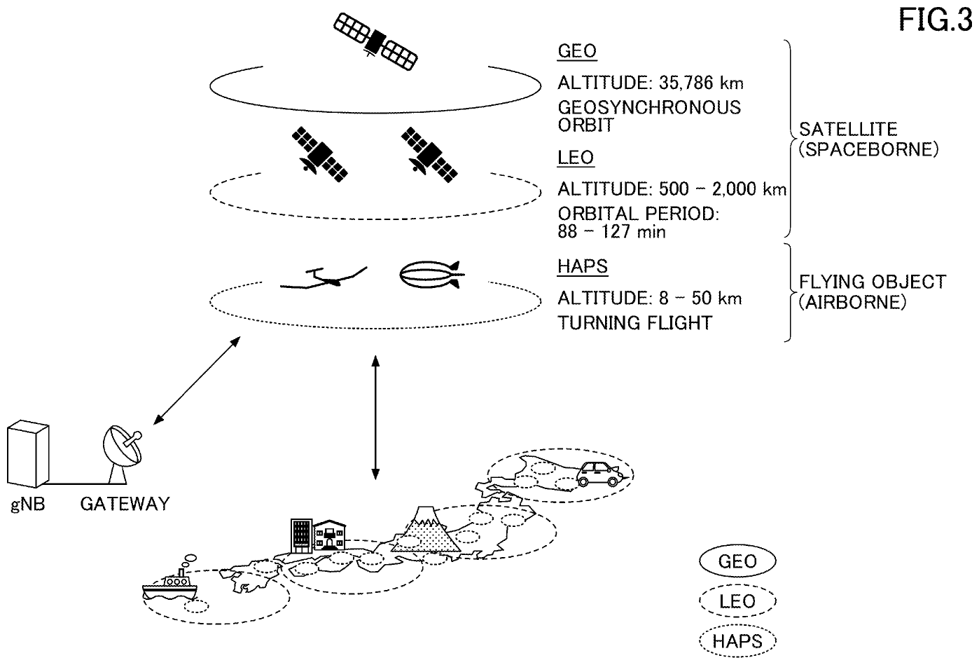

FIG. 3 is a third drawing for describing the non-terrestrial network. As illustrated in FIG. 3, the NTN is implemented by a satellite in space or a flying object in the air. For example, the GEO satellite may be a satellite located at an altitude of 35.786 km, with a geosynchronous orbit. For example, the LEO satellite may be a satellite located at an altitude of 500 km to 2000 km, and orbiting with a period of 88 minutes to 127 minutes. For example, the HAPS (High Altitude Platform Station) may be a flying object located at an altitude of 8 km to 50 km, and moving in an orbit, or a flying object moving differently.

As illustrated in FIG. 3, the GEO satellite, the LEO satellite, and the HAPS flying object may be connected to a terrestrial station gNB via a gateway. In addition, the service area may increase in an order of the HAPS, the LEO, and the GEO.

For example, the coverage of the 5G network can be enhanced by the NTN, with respect to the area with no service or the area with services. For example, the continuity, availability, and reliability of the services in a ship, bus, train or other important communications can also be improved by NTN. The NTN may be indicated by transmitting a dedicated parameter to the terminal 20, and the dedicated parameter may be a parameter related to TA (Timing Advance) determination based on information related to the satellite or the flying object, for example.

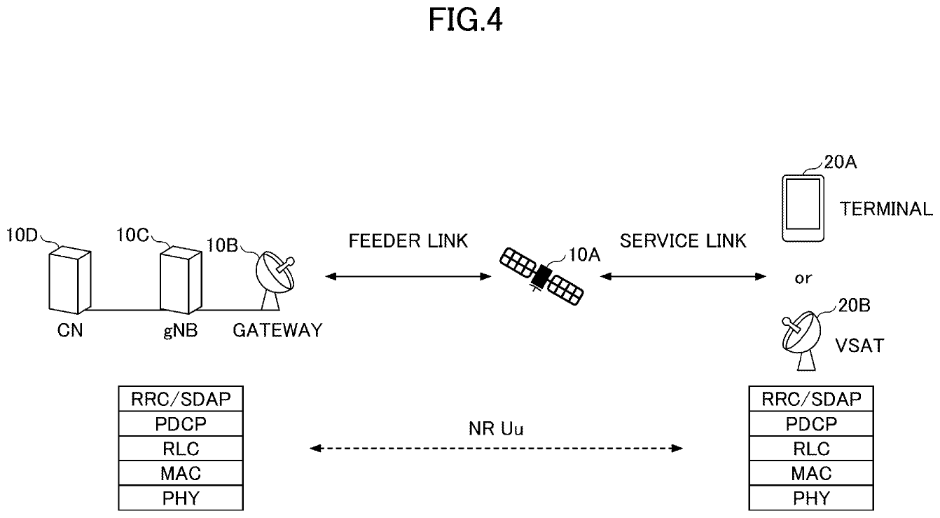

FIG. 4 is a fourth drawing for describing the non-terrestrial network. FIG. 4 illustrates an example of an NTN network architecture that is assumed in the case of a transparent payload. As illustrated in FIG. 4, a CN (Core Network) 10D, a gNB 10C, and a gateway 10B are connected. The gateway 10B is connected to the satellite 10A via a feeder link. The satellite 10A is connected to the terminal 20A or a VSAT (Very small aperture terminal) 20B via a service link. A NR Uu is established between the gNB 10C and the terminal 20A or the VSAT 20B.

In addition, as an assumption of the NTN network architecture, the FDD may be adopted, or the TDD may be available. Moreover, the terrestrial cell may be fixed or movable. Further, the terminal 20 may have a GNSS (Global Navigation Satellite System) capability. For example, in FR1, a hand-held device with power class 3 may be assumed. On the other hand, a VSAT device may be assumed at least in FR2.

In addition, a regenerative payload may be assumed in the NTN network architecture. For example, gNB functions may be implemented in the satellite or the flying object. Further, gNB-DU may be implemented in the satellite or the flying object, and gNB-CU may be provided as a terrestrial station.

In the NTN, it is necessary to consider a long propagation delay, an LEO or HAPS movement, and a communication via the GEO, the LEO or the HAPS. Because of these characteristics of the NTN, enhancement of HARQ operations is being studied. For example, the HARQ feedback may be disabled. In the case where the HARQ feedback is disabled, it is possible to transmit two consecutive DL transport blocks in a single HARQ process, without waiting for the feedback.

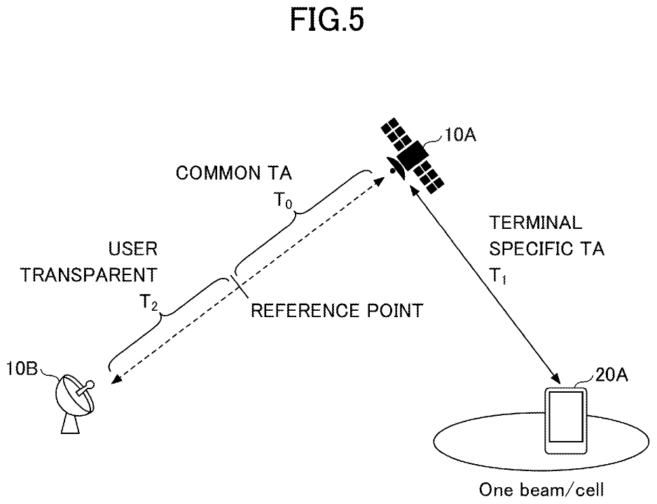

FIG. 5 is a drawing for describing an enhancement of the timing advance. In the conventional techniques of the NR and the like, a timing of the downlink or the uplink is adjusted only at a reference point (RP). In other words. the adjustment is performed at the RP so that the timings of the downlink and the uplink are aligned. The RP is flexibly determined between the terrestrial base station 10C or the gateway 10B, and the satellite 10A or the HAPS, according to the network implementation. In the following, the terrestrial base station 10C and the gateway 10B are also collectively referred to as the base station 10. In addition, the terminal 20A and the VSAT 20B are also collectively referred to as the terminal 20 when not distinguishing the terminal 20A and the VSAT 20B from each other.

The RP in the base station 10 is required to frequently broadcast information via the feeder link, in order to achieve a simple network implementation. In addition, the RP in the satellite 10A or the HAPS is required to have a backward compatibility of regenerated payload or ISL/IAL.

The terminal 20A may calculate a timing advance value TA_{Full} according to the following formula.

$${TA}_{Full} = {TA}_{Feeder link} + {TA}_{Service link}$$

In the formula, TA_{Feeder link} denotes an RTD (Round Trip Delay) at the feeder link, and is calculated from 2(T₀+T₂).

T₂ is compensated for by the network, and is a value indicating the timing advance that is transparent with respect to a user. T₂ may be a constant in order to simplify the implementation of the base station 10.

T₀ is a value indicating the timing advance common to all users, and is broadcast via an SIB. The reference point may be located in the service link, and in this case, T₀ has a negative value.

TA_{Service link} denotes an RTD in the service link, and is calculated from 2T₁. T₁ is a terminal-specific TA, and has a different value depending on the location of the terminal.

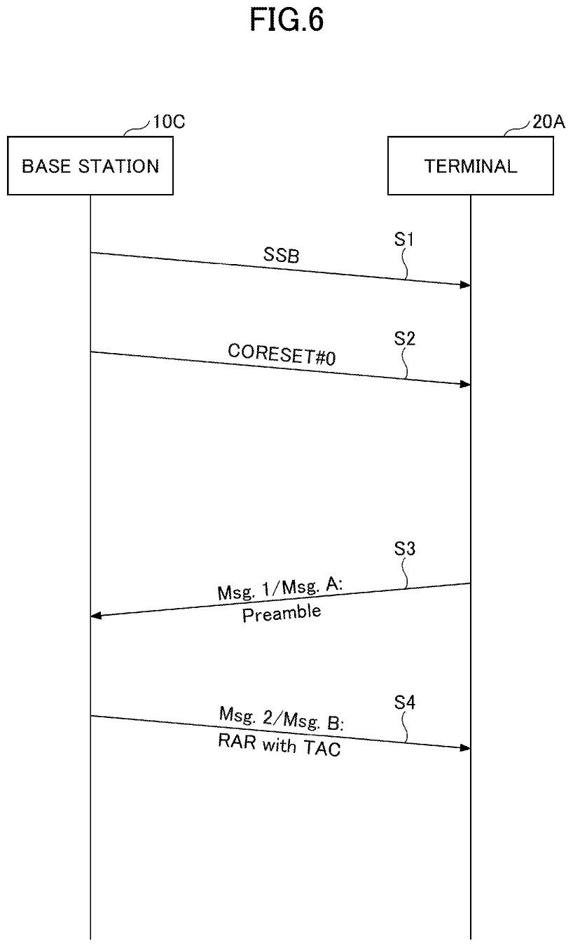

FIG. 6 is a flow chart illustrating an example of a calculation flow of the timing advance. The terminal 20 calculates a value indicating the timing advance during a period between an initial access and a RACH procedure.

The base station 10 transmits an SSB (Synchronization Signal Block) to the terminal 20 (step S1). The terminal 20 performs a time or frequency synchronization in the downlink, and detects an MIB (Master Information Block) included in the SSB.

Next, the base station 10 transmits a CORESET (Control-resource set) #0 to the terminal 20. The terminal 20 detects an SIB (System Information Block) included in the CORESET #0, and acquires a PRACH resource and a parameter of the common TA.

Next, the terminal 20 transmits a preamble, using a common TA (N_{TA,common}) determined from the parameter included in the SIB and a terminal-specific TA (N_{TA, UE-specific}) that is self-estimated (step S3). The preamble includes Msg1 or MsgA of the RACH procedure.

Next, the base station 10 transmits an RAR (Random Access Response) including a TAC (Timing Advance Command) to the terminal 20 (step S4). The RAR including the TAC includes Msg2 or MsgB of the RACH procedure. N_{TA} is determined based on the TAC. The terminal 20 uses, for the uplink synchronization, the common TA determined from the parameter included in the SIB, the terminal-specific TA that is self-estimated, and the TAC included in the RAR.

In an NR NTN, configuring the TA to be applied to the terminal to include four elements N_{TA}, N_{TA,common}, N_{TA, UE-specific}, and N_{TA,offset} is being studied, and the TA can be obtained from T_{TA}=(N_{TA}+N_{TA,common}+N_{TA, UE-specific}+N_{TA,offset})×T_{C}.

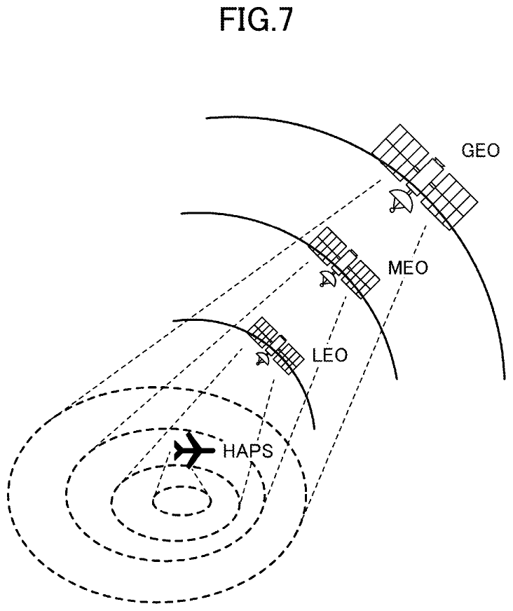

FIG. 7 is a diagram for describing the types of non-terrestrial networks. Examples of the types of non-terrestrial network include Geosynchronous Orbit (GEO), Medium-Earth Orbit (MEO), Low-Earth Orbit (LEO), and High Altitude Platform Station (HAPS).

The GEO is a satellite in a geosynchronous orbit, and is characterized by being stationary with respect to the earth. The MEO is a medium orbit satellite, and the LEO is a low orbit satellite. The MEO and the LEO are satellites orbiting the earth. The HAPS is a flying object that makes a turning flight.

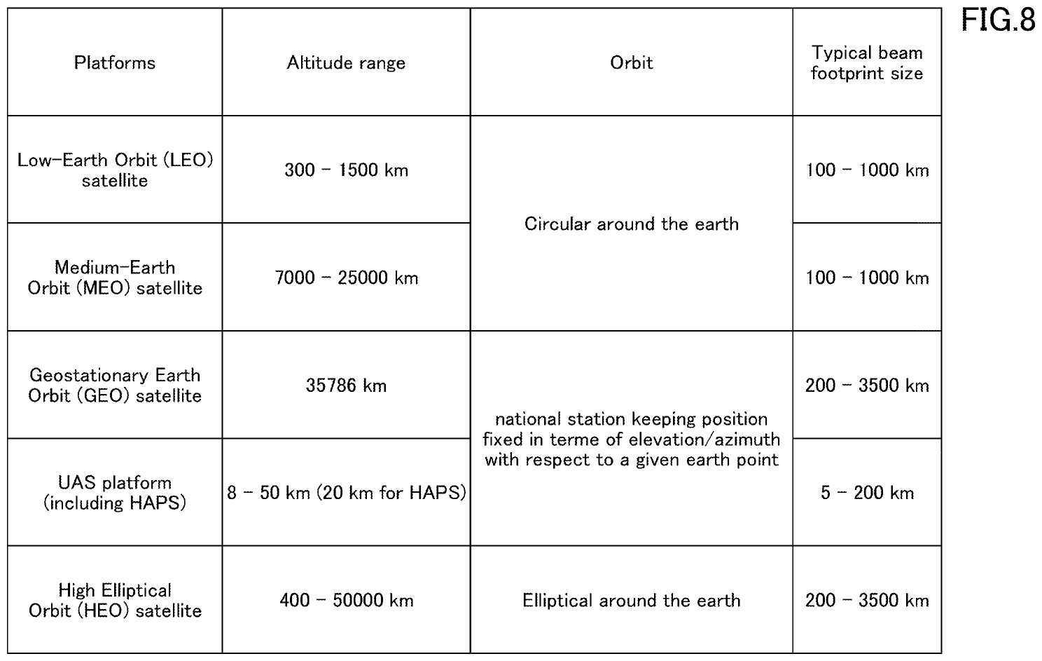

FIG. 8 is a drawing for describing the features of each type of non-terrestrial network. Each type of non-terrestrial network has a different altitude range, orbit, and typical beam footprint size. Different altitude ranges cause different propagation delays. In addition, different moving speeds with respect to the earth may generate different Doppler shifts, dynamic functions with different propagation delays, and the like.

### Problems in the Prior Art

Because the propagation delay of the NTN is large, the following functions are studied in the NTN of NR release 17.

A first function is a function of adjusting a timing relationship, and introduces K_{offset} and K_{mac} and designs ranges of the values thereof.

In the NTN, because a distance from the overflight base station to the terminal is very large, the propagation delay increases, and the timing of UL transmission cannot be correctly indicated to the terminal 20 solely by the timing advance and the UL slot indication (parameters K1 and K2). Hence, by introducing an offset K_{offset}, the UL slot indication may be performed using K1+K_{offset} or K2+K_{offset}. K1 may be applied to an offset from the PDSCH to the PUCCH, and K2 may be applied to an offset from the PDCCH to the PUSCH. K_{offset} may be cell-specific or UE-specific. The cell-specific K_{offset} may be used for initial access. The UE-specific K_{offset} may be used after connection completion. Only the cell-specific K_{offset} may be used, without using the UE-specific K_{offset}.

Similarly, K_{mac} may be introduced for the purpose of indicating the timing to start applying an MAC-CE command transmitted in the PDSCH, and indicating the timing by an offset 3×Nₛₗₒₜ^{sf,μ}+K_{mac}. This offset may be applied as an offset from the timing of a HARQ feedback corresponding to the PDSCH including the MAC-CE command.

A second function is a function of adjusting an uplink time and frequency synchronization, which introduces common TA parameters and designs a range of the values thereof.

In this case, considering the different propagation delays depending on the different NTN types, the parameters for adjusting the uplink time and the frequency synchronization and the parameters related to timings require different designs. For example, it is conceivable to specify a range of different values of K_{offset} or K_{mac} for each NTN type, so as to reduce the payload size. In addition, in order for the terminal 20 to recognize the ranges and the like of the values, an indication of the NTN type is required. However, there is a problem in that a method of defining and indicating the NTN type is conventionally not defined.

### Outline of Present Embodiment

In the present embodiment, a method for solving the above noted problem will be described. Hereinafter, as specific exemplary implementations, an exemplary implementation 1 through an exemplary implementation 4 will be described.

### Exemplary Implementations 1

In the present exemplary implementation, an example of defining the NTN type will be described.

### Exemplary Implementation 1-1

The NTN type may be defined by a platform type.

### <Option 1>

The NTN type may be an NTN type based on a general definition of the platform type. For example, the NTN type may be NTN type 1-GEO, NTN type 2-MEO, NTN type 3-LEO, NTN type 4-HAPS, or NTN type 5-ATG.

The NTN type may be any other NTN type associated with the platform type. In addition, the NTN type may also be a combination of NTN types (for example, NTN type 4-HAPS and ATG). Type X may include one of the satellite types and one of the other types, such as the HAPS.

### <Option 2>

The NTN type may be an NTN type based on a detailed definition of the platform type. For example, the NTN type may be classified based on the altitude. For example, the NTN type may be NTN type 1-GEO, NTN type 2-MEO, NTN type 3-LEO600 km, NTN type 4-LEO1200 km, NTN type 5-HAPS, or NTN type 6-ATG.

According to the exemplary implementation 1-1, a simple definition and classification of NTN types of simple NTN systems is applied.

### Exemplary Implementation 1-2

The NTN type may be defined by the satellite orbit.

### <Option 1>

The NTN type may be an NTN type based on the altitude of the platform. For example, the NTN type n may be defined by the altitude in a range of [H1n, H2n].

### <Option 2>

The NTN type may be an NTN type based on a moving speed of the platform. For example, the NTN type n may be defined by the moving speed in a range of [V1n, V2n].

### <Option 3>

The NTN type may be an NTN type based on the altitude and the moving speed of the platform. For example, the NTN type n may be defined by the altitude in the range of [H1n, H2n] and the moving speed in the range of [V1n, V2n].

According to the exemplary implementation 1-2, because the NTN type is defined in more detail, the wireless communication system may operate with more accurate parameters associated with the NTN type.

### Exemplary Implementation 1-3

The NTN type may be defined based on a system configuration (a carrier frequency and the like). The NTN types defined in the exemplary implementation 1-1 and the exemplary implementation 1-2 may further be classified into various types under various carrier frequencies.

For example, the NTN type n1 may be defined by the altitude in the range of [H1n, H2n] and the carrier frequency of FR1, and the NTN type n2 may be defined by the altitude in the range of [H1n, H2n] and the carrier frequency of FR2. The Ka band may be included in FR2. The NTN type n3 may be defined by the altitude in the range of [H1n, H2n] and the carrier frequency of the Ka band. The Ka band may refer to a band from 17.3 GHz to 20.2 GHz in the downlink, and a band from 27.0 GHz to 30 GHz in the uplink, or may refer to a band between FR1 and FR2.

According to the exemplary implementation 1-3, because the carrier frequency affects the parameter design of the NTN, more accurate parameters can be used by classifying the NTN type into fine classifications.

### Exemplary Implementations 2

The method of indicating the NTN type may be explicitly or implicitly defined.

### Exemplary Implementation 2-1

A method for explicitly indicating the NTN type will be described.

### <Option 1>

The terminal 20 may receive information indicating the NTN type {1, 2, 3, . . . } from the base station 10 through new signaling of SIB/RRC/MAC-CE or signaling without a common TA parameter, a satellite orbit, and the like.

### <Option 2>

The terminal 20 may receive information indicating the NTN type {1, 2, 3, . . . } from the base station 10, together with other parameters of the SIB/RRC/MAC-CE, the common TA parameters, and/or the satellite orbit data.

For example, the common TA parameters may be a common TA, a rate of change of the common TA, other parameters (other parameters of the common TA, such as a variation in the rate of change of the common TA, a reference time, a valid period, and the like, for example), or the NTN type associated with the common TA parameters.

According to the exemplary implementation 2-1, the terminal 20 can easily understand the NTN type.

### Exemplary Implementation 2-2

A method of implicitly indicating the NTN type will be described.

### <Option 1>

The terminal 20 may receive information implicitly indicating the NTN type {1, 2, 3, . . . } as the range of the values of the common TA parameters and/or the satellite orbit data from the base station 10. For example, in a case where the altitude value indicated by the satellite orbit data falls within the range of [H1n, H2n], the NTN type may be regarded as being the NTN type n.

In addition, in a case where both the values of the rate of change of the common TA and the variation in the rate of change of the common TA are 0, for example, the NTN type may be regarded as being GEO (or 1). In a case where the values of the common TA, the rate of change of the common TA, and the variation in the rate of change of the common TA are other than 0, the NTN type may be regarded as being LEO (or 3).

The range of detailed values of the parameters may be the same as that in the option 2 of the exemplary implementation 1-1.

### <Option 2>

The terminal 20 may receive information implicitly indicating the NTN type {1, 2, 3, . . . } as a parameter set of the common TA parameters and/or the satellite orbit data from the base station 10.

For example, in a case where only “the common TA” is indicated by the base station 10, the terminal 20 may determine the NTN type as GEO (or 1). Moreover, in a case where “the common TA, the rate of change of the common TA, and the variation in the rate of change of the common TA” are indicated by the base station 10, the terminal 20 may determine the NTN type as LEO (or 3).

According to the exemplary implementation 2-2, it is possible to reduce an overhead or a payload of the explicit signaling.

### Exemplary Implementation 2-3

A hybrid method of explicitly and implicitly indicating the NTN type will be described. The hybrid method of explicitly and implicitly indicating the NTN type may be used for a more detailed indication of the NTN type.

For example, the indication methods of both the exemplary implementation 2-1 and the exemplary implementation 2-2 may be used. For example, the terminal 20 may receive an indication of the platform of the NTN type {3}, that is, the LEO type, by the signaling of SIB/RRC/MAC-CE from the base station 10 that. Next, the terminal 20 may determine the LEO type as the LEO-600 km. based on the satellite elevation of 600 km, for example, indicated by the satellite orbit information received from the base station 10.

According to exemplary implementation 2-3, an appropriate trade-off between the overhead/payload and a terminal integrity can be obtained.

### Exemplary Implementation 2-4

The terminal 20 may determine the content or format of the information of the predetermined parameter, based on the explicit or implicit indication of the NTN type described above. In addition, the terminal 20 may determine the operation based on the explicit or implicit indication of the NTN type. For example, the terminal 20 may determine whether or not to update the common TA according to the NTN type. For example, the common TA may not be updated in the case where the NTN type is GEO, and the common TA may be updated in other cases.

For example, the terminal 20 determines the content or format of the common TA parameters described in exemplary implementations 4 which will be described later.

According to the exemplary implementation 2-4, it is possible to reduce the signaling overhead when indicating the specified parameter. The performance can be improved using more accurate parameters associated with the NTN type.

### Exemplary Implementation 3

An example in which the terminal 20 defines a terminal capability of the signaling associated with the supported NTN type, and reports the terminal capability to the base station 10, will be described.

The terminal capability that is reported may be a terminal capability related to whether or not to support the NTN type {1, 2, 3, . . . } or {GEO, MEO, LEO, HAPS, . . . }. The definition of the NTN type may be the same as that described in exemplary implementation 1-1.

One or more NTN types may be supported by one terminal 20.

The terminal 20 may report the terminal capability to the base station 10 using parameters of a higher layer such as the RRC, MAC-CE, and the like. The base station 10 may determine the serving NTN type based on the reported terminal capability, and communicate with the terminal 20 using the supported NTN type.

According to the exemplary implementation 3, it is possible to provide appropriate parameters to the terminal 20.

### Exemplary Implementation 4

Examples in which the common TA parameters associated with the NTN type and the terminal capability of the NTN type will be described.

As the background, based on evaluation of the LEO 600 km, the common TA varies rapidly with the movement of the LEO satellite. In order to support a valid period of approximately 10 seconds, the common TA parameters such as the common TA, the rate of change of the common TA, the variation in the rate of change of the common TA, and the like need to be indicated in the network of the LEO 600 km.

However, because the GEO satellite is relatively stationary with respect to the earth, the common TA of the GEO does not vary. In this case, a common TA drift rate and variation may not be required.

### Exemplary Implementation 4-1

Various sets of the common TA parameters are defined with respect to various NTN types and terminal capability of the NTN types. For example, “the common TA” may be used in the case of the GEO, “the common TA and the rate of change of the common TA” may be used in the case of the HAPS, and “the common TA, the rate of change of the common TA, and the variation in the rate of change of the common TA” may be used in the case of the LEO.

According to the exemplary implementation 4-1, it is possible to reduce the overhead or payload of the information required for the common TA parameters.

### Exemplary Implementation 4-2

Different ranges of the values of the common TA parameters associated with the NTN type and the terminal capability of the NTN type may be defined.

For example, the common TA may be [X1, X2] in the case of the GEOs [X3, X4] in the case of the LEO-600 km, [X5, X6] in the case of the LEO-1200 km, [X7, X8] in the case of the HAPS, and the like.

For example, the rate of change of the common TA may be [Y1, Y2] in the case of the GEO, [Y3, Y4] in the case of the LEO-600 km, [Y5, Y6] in the case of the LEO-1200 km, [Y7, Y8] in the case of the HAPS, and the like.

For example, the variation in the rate of change of the common TA may be [Z1, Z2] in the case of the GEO, [Z3, Z4] in the case of the LEO-600 km, [Z5, Z6] in the case of the LEO-1200 km. [Z7, Z8] in the case of the HAPS, and the like.

According to the exemplary implementation 4-2, it is possible to improve the performance by designing the range of the value of each NTN type in detail at a given overhead or payload.

### Exemplary Implementation 4-3

Different default values may be defined for the common TA parameters associated with the NTN type and the terminal capability of the NTN type.

For example, the common TA may be [x1] in the case of the GEO, [x2] in the case of the LEO-600 km, [x3] in the case of the LEO-1200 km, [x4] in the case of the HAPS, and the like.

For example, rate of change of the common TA may be [y1] in the case of the GEO, [y2] in the case of the LEO-600 km, [y3] in the case of the LEO-1200 km, [y4] in the case of the HAPS, and the like. For example, y1=0 according to a default setting.

For example, the variation in the rate of change of the common TA may be [z1] in the case of the GEO, [z2] in the case of the LEO-600 km, [z3] in the case of the LEO-1200 km, [z4] in the case of the HAPS, and the like. For example, z1= and z4=0 according to a default setting.

According to the exemplary implementation 4-3, it is possible to improve the performance by designing the range of the value of each NTN type in detail at a given overhead or payload.

The exemplary implementation 4-2 and the exemplary implementation 4-3 may be used for the same set of common TA parameters of different NTN types, and may also be used for the different sets of common TA parameters defined in the exemplary implementation 4-1.

For example, in the case of the GEO, the common TA may be a common TA [X1, X2] having a default value [x1].

In addition, in the case of the LEO-600 km, for example, the common TA may be a common TA [X3, X4] having a default value [x2], the rate of change of the common TA may be [Y3, Y4] having a default value [y2], and the variation in the rate of change of the common TA may be [Z3, Z4] having a default value [z2].

Further, in the case of the HAPS, for example, the common TA may be a common TA [X7, X8] having a default value [x4], and the rate of change of the common TA may be [Y7, Y8] having a default value [y4].

Thus, by designing the range of values and parameters of each NTN type in detail, it is possible to improve the performance and to reduce the overhead/payload.

### Device Configuration

Next, a functional configuration example of the base station 10 and the terminal 20 for performing the above noted processes and operations will be described. The base station 10 and terminal 20 include functions for implementing the embodiments described above. Each of the base station 10 and the terminal 20 may include only proposed functions of one of the embodiments.

### <Base Station 10>

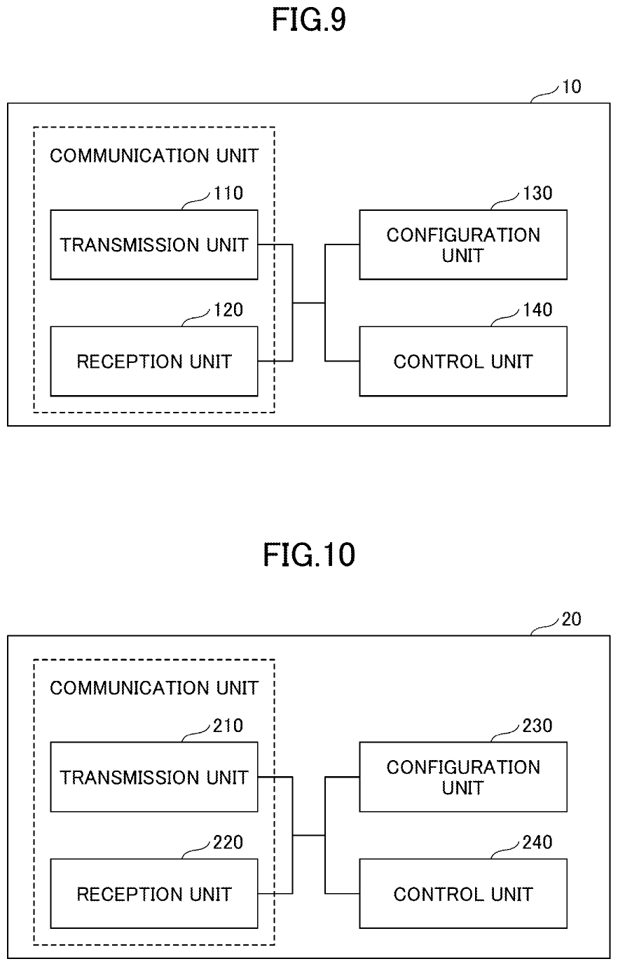

FIG. 9 is a drawing illustrating an example of the functional structure of the base station 10. As illustrated in FIG. 9, the base station 10 includes a transmission unit 110, a reception unit 120, a configuration unit 130, and a control unit 140. The functional structure illustrated in FIG. 9 is merely an example. Functional divisions and names of the functional units may be arbitrary as long as the operations according to an embodiment of the present invention can be performed. The transmission unit 110 and the reception unit 120 may be referred to as a communication unit.

The transmission unit 110 includes functions for generating a signal to be transmitted to the terminal 20, and wirelessly transmitting the signal. The reception unit 120 includes functions for receiving various signals transmitted from the terminal 20, and acquiring information of a higher layer from the received signals, for example. In addition, the transmission unit 110 includes functions for transmitting NR-PSS, NR-SSS, NR-PBCH, DL/UL control signals, DL data, and the like to the terminal 20. Further, the transmission unit 110 transmits the configuration information and the like described in the embodiment.

The configuration unit 130 stores pre-configured configuration information and various configuration information to be transmitted to the terminal 20 in a storage device, and reads the stored configuration information from the storage device, as required. The control unit 140 performs a control and the like of the entire base station 10, including control related to signal transmission and reception, for example. A functional unit related to the signal transmission in the control unit 140 may be included in the transmission unit 110, and a functional unit related to the signal reception in the control unit 140 may be included in the reception unit 120. Further, the transmission unit 110 and the reception unit 120 may be referred to as a transmitter and a receive respectively.

### <Terminal 20>

FIG. 10 is a drawing illustrating an example of a functional configuration of the terminal 20. As illustrated in FIG. 10, the terminal 20 includes a transmission unit 210, a reception unit 220, a configuration unit 230, and a control unit 240. The functional structure illustrated in FIG. 10 is merely an example. Functional divisions and names of functional units may be arbitrary as long as the operations according to an embodiment of the present invention can be performed. The transmission unit 210 and the reception unit 220 may be referred to as a communication unit.

The transmission unit 210 generates a transmission signal from transmission data, and wirelessly transmits the transmission signal. The reception unit 220 wirelessly receives various signals, and acquires signals of a higher layer from the received physical layer signals. In addition, the transmission unit 210 transmits an HARQ-ACK, and the reception unit 220 receives the configuration information described in the embodiment.

The configuration unit 230 stores various configuration information received from the base station 10 via the reception unit 220 in a storage device, and reads the stored configuration information from the storage device, as required. The configuration unit 230 also stores pre-configured configuration information. The control unit 240 performs a control and the like of the entire terminal 20, including control related to signal transmission and reception. A functional unit related to the signal transmission in the control unit 240 may be included in the transmission unit 210, and the functional unit related to the signal reception in the control unit 240 may be included in the reception unit 220. Further, the transmission unit 210 and the reception unit 220 may be referred to as a transmitter and a receiver, respectively.

A terminal according to an embodiment may be configured as a terminal described in each of the items below. In addition, the following communication method may be implemented.

### Configuration Related Present Embodiment

### (First Item)

A terminal that performs a communication with a base station via a satellite or a flying object, the terminal comprising:
a reception unit configured to receive from the base station, during the communication with the base station, information indicating a type of a non-terrestrial network; and
a control unit configured to perform a control based on the type of the non-terrestrial network.

### (Second Item)

The terminal according to first item, wherein the information indicating the type of the non-terrestrial network is an identifier indicating the type of the non-terrestrial network.

### (Third Item)

The terminal according to first item, wherein the control unit determines the type of the non-terrestrial network, based on the information received from the base station.

### (Fourth Item)

The terminal according to any one of first through third items, wherein the control unit assumes, as a parameter related to a common timing advance, a value according to the type of the non-terrestrial network.

### (Fifth Item)

A communication method performed by a terminal that performs a communication with a base station via a satellite or a flying object, the communication method comprising:
receiving, from the base station during the communication with the base station, information indicating a type of a non-terrestrial network; and
performing a control based on the type of the non-terrestrial network.

According to any one of the above configurations, a technology is provided that enables the type of the non-terrestrial network to be indicated. According to the second item, the type of the non-terrestrial network can be clearly indicated by an identifier. According to the third item, it is possible to cause the terminal to determine the type of the non-terrestrial network. According to the fourth item, it is possible to appropriate assume a parameter related to the common timing advance.

### (Hardware Structure)

The block diagrams (FIG. 9 and FIG. 10) used for describing the embodiment illustrate blocks in functional units. These functional blocks (function units) can be implemented by an arbitrary combination of hardware and/or software. Further, means for implementing each functional block is not particularly limited. In other words, each functional block may be implemented by a single apparatus in which multiple elements are physically and/or logically coupled, or may be implemented by two or more apparatuses that are physically and/or logically separated and are directly or indirectly connected (using wired, wireless, and the like, for example). The functional blocks may be implemented by the single apparatus or the two or more apparatuses described above in combination with software.

Functions include, but are not limited to, judging, determining, assessing, calculating, computing, processing, deriving, investigating, searching, checking, receiving, transmitting, outputting, accessing, resolving, selecting, planning, establishing, comparing, assuming, expecting, deeming, broadcasting, notifying, communicating, forwarding, configuring, reconfiguring, allocating, mapping, assigning, and the like. For example, a functional block (component) that performs a transmitting function is referred to as a transmitting unit or a transmitter. In either case, the implementation method is not particularly limited, as described above.

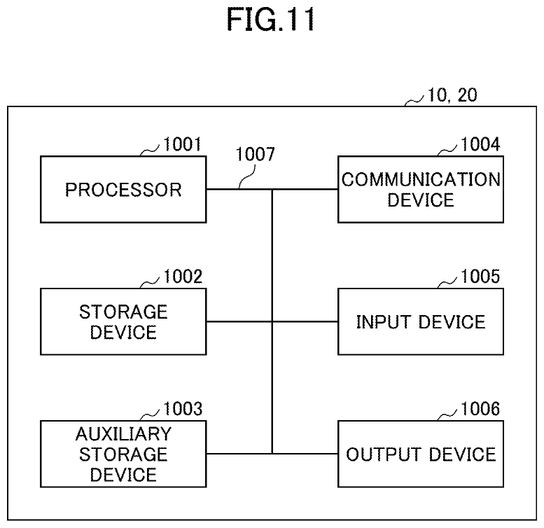

For example, the base station 10, terminal 20, and the like according to an embodiment of the present disclosure may function as a computer for performing processes of the wireless communication method of the present disclosure. FIG. 11 is a drawing illustrating an example of hardware structures of the base station 10 and terminal 20 according to an embodiment of the present disclosure. The base station 10 and the terminal 20 described above may physically be configured by a computer apparatus including a processor 1001, a storage device 1002, an auxiliary storage device 1003, a communication device 1004, an input device 1005, an output device 1006, a bus 1007, and the like.

It should be noted that, in the following description, the term “apparatus” can be replaced by a circuit, a device, a unit, and the like. The hardware structures of the base station 10 and terminal 20 may be configured to include one or more apparatuses illustrated in the figure, or may be configured not to include some of the apparatuses.

Each function of the base station 10 and terminal 20 can be implemented by causing predetermined software (programs) to be read onto a hardware element, such as the processor 1001, the storage device 1002, and the like to perform operations by the processor 1001, and control the communication performed by the communication device 1004 and control reading and/or writing of data with respect to the storage device 1002 and the auxiliary storage device 1003.

The processor 1001 controls the entire computer by controlling an operating system, for example. The processor 1001 may be configured by a CPU (Central Processing Unit) including an interface with a peripheral apparatus, a control apparatus, a calculation apparatus, a register, and the like. For example, the control unit 140, the control unit 240, and the like described above may be implemented by the processor 1001.

Further, the processor 1001 reads out onto the storage device 1002 a program (program code), a software module, data, and the like from the auxiliary storage device 1003 and/or the communication device 1004, and performs various processes according to the read program, software module, data, and the like. The program in this case is a program that causes the computer to perform at least some of the operations according to an embodiment described above. For example, the control unit 140 of the base station 10 illustrated in FIG. 9 may be implemented by a control program stored in the storage device 1002 and executed by the processor 1001. For example, the control unit 240 of the terminal 20 illustrated in FIG. 10 may be implemented by a control program stored in the storage device 1002 and executed by the processor 1001. The various processes are performed by a single processor 1001 in the example described above, however, the processes may be performed simultaneously or sequentially by two or more processors 1001. The processor 1001 may be implemented by one or more chips. The program may be transmitted from a network via a telecommunication line.

The storage device 1002 is a computer-readable recording medium, and may be configured by at least one medium selected from a ROM (Read Only Memory), an EPROM (Erasable Programmable ROM), an EEPROM (Electrically Erasable Programmable ROM), a RAM (Random Access Memory), and the like, for example. The storage device 1002 may be referred to as a register, a cache, a main memory, and the like. The storage device 1002 is capable of storing programs (program codes), software modules, and the like that are executable by the computer to perform the communication process according to an embodiment of the present disclosure.

The auxiliary storage device 1003 is a computer-readable recording medium, and may be configured by at least one medium selected from an optical disk, such as a CD-ROM (Compact Disc ROM) and the like, a hard disk drive, a flexible disk, a magneto optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, and the like, for example. The storage medium may be a database including the storage device 1002 and/or the auxiliary storage device 1003, a server, or any other appropriate medium, for example.

The communication device 1004 is a hardware element (transmission and reception device) for performing a communication between computers via a wired network and/or a wireless network, and may be referred to as a network device, a network controller, a network card, a communication module, and the like, for example. The communication device 1004 may be configured to include a high frequency switch, a duplexer, a filter, a frequency synthesizer, and the like to implement a frequency division duplex (FDD) and/or a time division duplex (TDD), for example. For example, a transmitting and receiving antenna, an amplifier unit, a transmitting and receiving unit, a transmission line interface, and the like may be implemented by the communication device 1004. The transmitting and receiving unit may be physically or logically divided into a transmitting unit and a receiving unit.

The input device 1005 is an input device (for example, a keyboard, a mouse, a microphone, a switch, a button, a sensor, and the like) that receives an external input. The output device 1006 is an output device (for example, a display, a speaker, an LED lamp, and the like) that makes an output to the outside. The input device 1005 and the output device 1006 may be integrated into a single device (for example, a touchscreen panel).

In addition, the apparatuses, such as the processor 1001, the storage device 1002, and the like are connected to one another via the bus 1007 used for communication of information. The bus 1007 may be configured using a single bus, or may be configured using different buses between the apparatuses.

Further, each of the base station 10 and terminal 20 may be configured to include a hardware element, such as a microprocessor, a DSP (Digital Signal Processor), an ASIC (Application Specific Integrated Circuit), a PLD (Programmable Logic Device), an FPGA (Field Programmable Gate Array), and the like, and a part or all of each functional block may be implemented by the hardware element. For example, the processor 1001 may be implemented by at least one of the hardware elements described above.

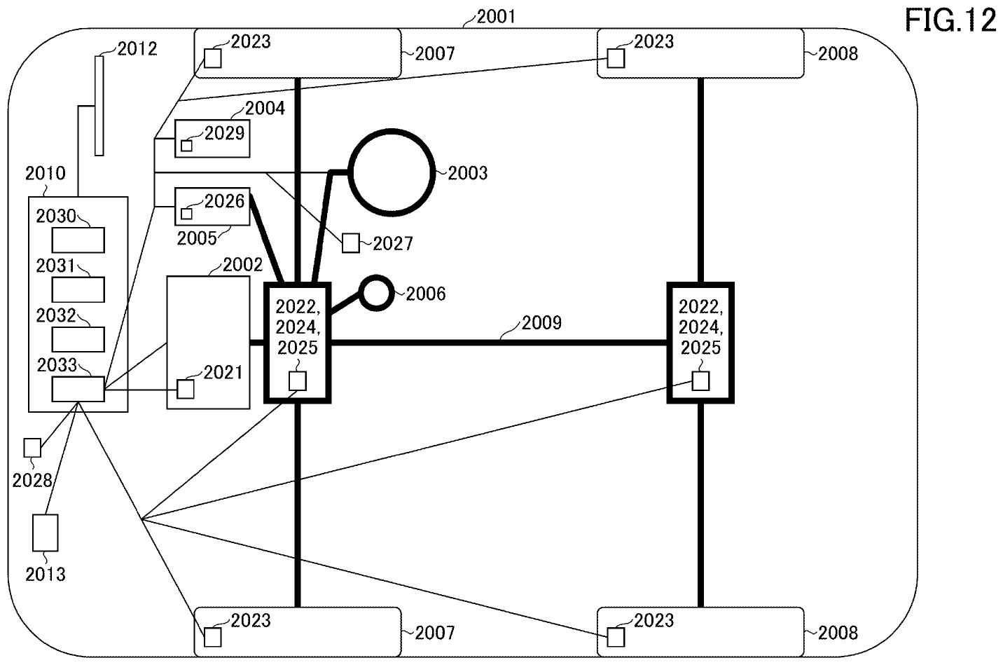

FIG. 12 illustrates an example of a configuration of a vehicle 2001. As illustrated in FIG. 12, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 through 2029, an information service unit 2012, and a communication module 2013. The aspects/embodiments described in the present disclosure may be applied to a communication device installed in the vehicle 2001, and may be applied to the communication module 2013, for example.

The drive unit 2002 may be configured to include an engine, a motor, and a hybrid of an engine and a motor, for example. The steering unit 2003 includes at least a steering wheel (also called a handle), and is configured to steer the front wheels and/or the rear wheels based on the operation of the steering wheel operated by the user.

The electronic control unit 2010 is configured to include a microprocessor 2031, a memory (ROM, RAM) 2032, and a communication port (IO port) 2033. The electronic control unit 2010 receives signals from the various sensors 2021 through 2029 provided in the vehicle 2001. The electronic control unit 2010 may be referred to as an ECU (Electronic control unit).

The signals from the various sensors 2021 through 2029 include a current signal from the current sensor 2021 which senses a motor current, a front or rear wheel rotation speed signal acquired by the rotation speed sensor 2022, a front or rear wheel pneumatic signal acquired by the pneumatic sensor 2023, a vehicle speed signal acquired by the vehicle speed sensor 2024, an acceleration signal acquired by the acceleration sensor 2025, an accelerator pedal depression amount signal acquired by the accelerator pedal sensor 2029, a brake pedal depression amount signal acquired by the brake pedal sensor 2026, an operation signal of a shift lever acquired by the shift lever sensor 2027, and a detection signal acquired by the object detection sensor 2028 for detecting an obstacle, a vehicle, a pedestrian, and the like.

The information service unit 2012 is configured to include various devices, such as a car navigation system, an audio system, a speaker, a television, and a radio for providing various kinds of information, such as driving information, traffic information, entertainment information, and the like, and one or more ECUs for controlling the various devices. The information service unit 2012 provides various types of multimedia information and multimedia services to an occupant of the vehicle 2001, by utilizing information acquired from an external device via the communication module 2013 and the like.

A driving support system unit 2030 is configured to include various devices, such as a millimeter wave radar, a LIDAR (Light Detection and Ranging), a camera, a positioning locator (for example, GNSS and the like), map information (for example, a high definition (HD) map, an autonomous vehicle (AV) map, and the like), a gyro system (for example, an IMU (Inertial Measurement Unit), an INS (Inertial Navigation System), and the like), an AI (Artificial Intelligence) chip, and an AI processor for providing functions to prevent accidents and reduce a driving load on a driver, and one or more ECUs for controlling the various devices. In addition, the driving support system unit 2030 transmits and receives various types of information via the communication module 2013 to implement a driving support function or an autonomous driving function.

The communication module 2013 may communicate with the microprocessor 2031 and constituent elements of the vehicle 2001 via a communication port. For example, the communication module 2013 transmits data to and receives data from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and the sensors 2021 through 2029 provided in the vehicle 2001, via the communication port 2033.

The communication module 2013 is a communication device that is controllable by the microprocessor 2031 of the electronic control unit 2010 and is capable of communicating with the external device. For example, various kinds of information are transmitted to and received from external devices through wireless communication. The communication module 2013 may be provided inside or outside the electronic control unit 2010. The external device may include a base station, a mobile station, and the like, for example,

The communication module 2013 transmits a current signal from the current sensor, which is input to the electronic control unit 2010, to the external device through wireless communication. The communication module 2013 also transmits, to the external device through wireless communication, the front or rear wheel rotation speed signal acquired by the rotation speed sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the accelerator pedal depression amount signal acquired by the accelerator pedal sensor 2029, the brake pedal depression amount signal acquired by the brake pedal sensor 2026, the operation signal of the shift lever acquired by the shift lever sensor 2027, and the detection signal acquired by the object detection sensor 2028 for detecting the obstacle, the vehicle, the pedestrian, and the like, that are input to the electronic control unit 2010.

The communication module 2013 receives various information (traffic information, signal information, inter-vehicle information, and the like) transmitted from the external device, and displays the received information on the information service unit 2012 provided in the vehicle 2001. In addition, the communication module 2013 stores the various information received from the external device in the memory 2032 that is utilizable by the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021 through 2029, and the like provided in vehicle 2001.

### Supplement To Embodiments

The embodiments of the present invention are described above. however, the disclosed invention is not limited to the described embodiments, and a person skilled in the art would understand that various modifications, variations, alternatives, replacements, and the like of the embodiments are possible. In order to facilitate understanding of the present invention, specific values are used in the description, however, unless otherwise specified, the specific values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and the flow charts described in the embodiments of the present invention may be changed as long as there is no contradiction. For the sake of convenience of description, the base station 10 and the terminal 20 are described using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, indication of information may be performed not only by methods described in an aspect/embodiment of the present specification but also by a method other than those described in an aspect/embodiment of the present specification. For example, the information transmission may be performed by physical layer signaling (for example, DCI (Downlink Control Information), UCI (Uplink Control Information)), upper layer signaling (for example, RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be an RRC connection setup message, an RRC connection reconfiguration message, and the like, for example.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer, decimal)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced, modified, developed, or defined therefrom. Further, multiple systems may also be applied in combination (for example, at least one of LTE and LTE-A combined with 5G, and the like).

The order of processing steps, sequences, flow charts and the like of an aspect/embodiment described in the present specification may be changed as long as there is no contradiction. For example, in a method described in the present disclosure, elements of various steps are presented in an exemplary order, and the order is not limited to the specific order presented.

The particular operations, that are described as being performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above case, a single network node other than the base station 10 is provided in the described example, however, a combination of multiple other network nodes (for example, MME and S-GW) may be provided.

The information or signals and the like described in the present disclosure may be output from a higher layer (or lower layer) to a lower layer (or higher layer). The information or signals may be input or output through multiple network nodes.

The input or output information and the like may be stored at a specific location (for example, memory) or managed using a management table. The input or output information and the like may be overwritten, updated, or added. The information and the like that is output may be deleted. The information and the like that is input may be transmitted to another apparatus.

A decision or a determination in an embodiment of the present invention may be realized by a value (0 or 1) represented by one bit, by a Boolean value (true or false), or by comparison of numerical values (for example, comparison with a predetermined value).

Software should be broadly interpreted to mean, whether referred to as software, firmware, middle ware, microcode, hardware description language, or by any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL) and the like) and wireless technologies (infrared, microwave, and the like), at least one of these wired line technologies and wireless technologies is included within the definition of the transmission medium.

Information, a signal, and the like described in the present disclosure may be represented using any one of various different technologies. For example, data, an instruction, a command, information, a signal, a bit, a symbol, a chip, and the like, described throughout the description above, may be represented by a voltage, an electric current, electromagnetic waves, magnetic fields, a magnetic particle, optical fields, a photon, or a combination thereof.

It should be noted that a term used in the present disclosure and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, and the like.

The terms “system” and “network” as used in the present disclosure may be used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used in any limiting way. Further, the mathematical formulas and the like that use these parameters may differ from those explicitly disclosed in the present disclosure. Because the various channels (for example, PUCCH, PDCCH, and the like) and information elements may be identified by any suitable names, the various names assigned to these various channels and information elements are not used in any limiting way.

In the present disclosure, the terms “BS: base station”, “radio base station”, “base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like, may be used interchangeably. The base station may be referred to as a macro-cell, a small cell, a femtocell, a picocell, and the like.

The base station may accommodate one or more (for example, three) cells. In the case where the base station accommodates a plurality of cells, the entire coverage area of the base station may be divided into a plurality of smaller areas, each smaller area may provide communication services by means of a base station subsystem (for example, an indoor small base station (Remote Radio Head (RRH). The term “cell” or “sector” refers to a part or all of the coverage area of at least one of the base station and base station subsystem that provides the communication services at the coverage.

In the present disclosure, terms such as “Mobile Station (MS)”, “user terminal”, “User Equipment (UE)”, “terminal”, and the like may be used interchangeably.

In some cases, the mobile station may be referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station and the mobile station may be referred to as a transmission apparatus, reception apparatus, communication apparatus, and the like. The at least one of the base station and the mobile station may be a device installed on the mobile station, the mobile station itself, and the like. The mobile station may be a vehicle (for example, a car, an airplane, and the like), an unmanned mobile body (for example, a drone, an automated vehicle, and the like), or a robot (manned or unmanned). At least one of the base station and the mobile station may include an apparatus that does not necessarily move during the communication operation. For example, at least one of the base station and the mobile station may be an IoT (Internet of Things) device, such as a sensor and the like.

Further, the base station in the present disclosure may be replaced by the user terminal. For example, each aspect/embodiment of the present disclosure may be applied to a configuration in which the communication between the base station and the user terminal is replaced by the communication between multiple terminals 20 (may be referred to as D2D (Device-to-Device), V2X (Vehicle-to-Everything), and the like, for example). In this case, the terminal 20 may be configured to include the functions of the base station 10 described above. Further, the terms “up” and “down” may also be replaced by a term (for example, “side”) corresponding to terminal-to-terminal communication. For example, an uplink channel, a downlink channel, and the like may be replaced by a sidelink channel.

Similarly, the user terminal in the present disclosure may be replaced by the base station. In this case, the base station may be configured to include the functions of the user terminal described above.

The term “determining” used in the present disclosure may include various actions or operations. The “determining” may include “judging”, “calculating”, “computing”, “processing”, “deriving”, “investigating”, “looking up, search, inquiry” (for example, looking up a table, database, or other data structures), “ascertaining”, and the like. In addition, “determining” may include “receiving” (for example, receiving information), “transmitting” (for example, transmitting information), “inputting”, “outputting”, “accessing” (for example, accessing data in a memory), and the like. Further, the “determining” may include “resolving”, “selecting”, “choosing”, “establishing”, “comparing”, and the like. In other words, the “determining” may include “determining” a certain action or operation. Moreover, “determining” may be replaced by “assuming”, “expecting”, “considering”, and the like.

The term “connected” or “coupled” or any variation thereof means any direct or indirect connection or coupling between two or more elements, and may include the presence of one or more intermediate elements between the two elements that are “connected” or “coupled” to each other. The coupling or connection between the elements may be physical, logical, or a combination thereof. For example, “connection” may be replaced by “access”. As used in the present disclosure, the two elements may be regarded as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present disclosure does not mean “based on only” unless otherwise specifically indicated. In other words, the term “based on” includes both “based on only” and “based on at least”.

Any reference to an element using names such as “first” or “second” as used in the present disclosure does not generally limit the amount or the order of the elements. These names may be used in the present disclosure as a convenient way to distinguish two or more elements. Therefore, a reference to the first and second elements does not imply that only two elements may be employed or that the first element must in some way precede the second element.

The term “means” included in the configuration of each of the above apparatuses may be replaced by “parts”, “circuits”, “devices”, and the like.

In the case where the terms “include”, “including” and variations thereof are used in the present disclosure, these terms are intended to be inclusive similar to the term “comprising”. Further, the term “or” used in the present disclosure is not intended to be an “exclusive or”.

A radio frame may be configured by one or more frames in the time domain. Each of the one or more frames in the time domain may be referred to as a subframe. The subframe may further include one or more slots in the time domain. The subframe may have a fixed length of time (for example, 1 ms) independent from numerology.

The numerology may be a communication parameter that is applied to at least one of the transmission or reception of the signal or channel. The numerology may indicate at least one of Sub-Carrier Spacing (SCS), bandwidth, symbol length, cyclic prefix length, Transmission Time Interval (TTI), number of symbols per TTI, radio frame configuration, specific filtering process performed by the transceiver in the frequency domain, specific windowing process performed by the transceiver in the time domain, and the like, for example.

The slot may be configured by one or more symbols in the time domain (OFDM (Orthogonal Frequency Division Multiplexing) symbols, SC-FDMA (Single Carrier Frequency Division Multiple Access) symbols, and the like). The slot may be a time unit based on the numerology.

The slot may include a plurality of mini slots. Each mini slot may be configured by one or more symbols in the time domain. In addition, the mini slot may be referred to as a sub-slot. The mini slot may include fewer symbols than the slot. PDSCH (or PUSCH) transmitted in time units greater than the mini slot may be referred to as PDSCH (or PUSCH) mapping type A. The PDSCH (or PUSCH) transmitted using the mini slot may be referred to as PDSCH (or PUSCH) mapping type B.

The radio frame, the subframe, the slot, the mini slot, and the symbol all represent time units for transmitting signals. Different names may be used for referring to the radio frame, the subframe, the slot, the mini slot, and the symbol, respectively.

For example, one subframe may be referred to as a Transmission Time Interval (TTI), multiple consecutive subframes may be referred to as the TTI, and one slot or one mini slot may be referred to as the TTI. In other words, at least one of the subframe and the TTI may be a subframe (1 ms) of an existing LTE, or a period shorter than 1 ms (for example, 1 to 13 symbols), or a period longer than 1 ms. It should be noted that the unit representing the TTI may be referred to as a slot, a mini slot, and the like, rather than a subframe.

The TTI refers to a minimum time unit for scheduling in the wireless communication, for example. For example, in an LTE system, a base station performs scheduling with respect to each terminal 20 to allocate radio resources (a frequency bandwidth, a transmission power, and the like usable in the terminal 20) in TTI units. The definition of TTI is not limited to the above.

The TTI may be a transmission time unit of channel-encoded data packet (transport block), code block, codeword, and the like, or may be a processing unit of scheduling, link adaptation, and the like. When the TTI is given, a time interval (for example, the number of symbols) during which the transport block, the code block, the codeword, and the like is actually mapped may be shorter than the TTI.

In a case where one slot or one mini slot is referred to as the TTI, one or more TTIs (that is, one or more slots or one or more mini slots) may be a minimum time unit of the scheduling. Further, the number of slots (the number of mini slots) configuring the minimum time unit of the scheduling may be controlled.

The TTI having a time length of 1 ms may be referred to as a normal TTI (a TTI in LTE Rel. 8-12), a general TTI, a long TTI, a general subframe, a normal subframe, a long subframe, a slot, and the like. The TTI that is shorter than the normal TTI may be referred to as a shortened TTI, a short TTI, a partial TTI (or fractional TTI), a shortened subframe, a short subframe, a mini slot, a subslot, a slot, and the like.

The long TTI (for example, the normal TTI, the subframe, and the like) may be replaced by a TTI having a time length exceeding 1 ms, and the short TTI (for example, shortened TTI and the like) may be replaced by a TTI having a TTI length of 1 ms or longer and shorter than the TTI length of the long TTI.

A resource block (RB) is a resource allocation unit of the time domain and the frequency domain, and may include one or more consecutive sub-carriers in the frequency domain. The number of sub carriers included in the RB may be the same, regardless of the numerology, and may be 12, for example. The number of sub-carriers included in the RB may be determined based on the numerology.

Moreover, the time domain of the RB may include one or more symbols, which may be 1 slot, 1 mini slot, 1 subframe, or 1 TTI in length. 1 TTI, 1 subframe, and the like may be configured by one or more resource blocks, respectively.

One or more RBs may be referred to as physical resource blocks (PRBs, Physical RBs), sub-carrier groups (SCGs), resource element groups (REGs), PRB pairs, RB pairs, and the like.

Further, the resource block may be configured by one or more resource elements (REs). For example, 1 RE may be a radio resource area of 1 sub-carrier and 1 symbol.

A bandwidth part (BWP) (which may also be referred to as a partial bandwidth and the like) may represent a subset of consecutive common RBs (common Resource Blocks) for a given numerology in a carrier. The common RB may be identified by an index of the RB with reference to a common reference point of the carrier. The PRB may be defined in a BWP, and may be numbered within the BWP.

The BWP may include a BWP for UL (UL BWP) and a BWP for DL (DL BWP). With respect to the terminal 20, one or more BWPs may be configured in one carrier.

At least one of the configured BWPs may be active, and the terminal 20 need not assume transmitting and receiving signals/channels outside the active BWP. The terms “cell”, “carrier”, and the like in this disclosure may be replaced by “BWP”.

Structures of the radio frame, the subframe, the slot, the mini slot, the symbol, and the like described above are merely examples. For example, the number of subframes included in the radio frame, the number of slots per subframe or radio frame, the number of mini slots included in the slot, the number of symbols and RBs included in the slot or mini slot, the number of sub-carriers included in the RB, the number of symbols in the TTI, the symbol length, the cyclic prefix (CP) length, and the like may be modified in various ways.

In the present disclosure, where an article such as “a”, “an”, or “the” is added by translation, for example, the disclosure may include a noun, following such an article, that is plural.

In the present disclosure, the expression “A and B are different” may mean that “A and B are different from each other”. The expression “A and B are different” may also mean that “A and B are different from C”. Terms such as “separated”, “coupled”, and the like may also be interpreted similarly to the term “different”.

Each aspect/embodiment described in the present disclosure may be used independently, may be used in combination, or may be used by switching according to operations. In addition, indication of predetermined information (for example, notifying “X”) is not limited to an explicit indication, and may be performed by an implicit indication (for example, by not notifying predetermined information).

Although the present disclosure is explained in detail above, it is apparent to a person skilled in the art that the present disclosure is not limited to one or more embodiments of the present disclosure described above. Modifications, variations, and the like of the present disclosure may be made without departing from the subject matter and the scope of the present disclosure defined by the descriptions of claims. Accordingly, the description of the present disclosure is for illustrative purposes only, and is not intended to limit the present disclosure.

### DESCRIPTION OF THE REFERENCE NUMERALS

10: Base station
10A: Satellite
10B: Gateway
10C: Terrestrial base station
10D: CN
10E: Flying object
110: Transmission unit
120: Reception unit
130: Configuration unit
140: Control unit
20: Terminal
210: Transmission unit
220: Reception unit
230: Configuration unit
240: Control unit
30: Core network
1001: Processor
1002: Storage device
1003: Auxiliary storage device
1004: Communication device
1005: Input device
1006: Output device
2001: Vehicle
2002: Drive unit
2003: Steering unit
2004: Accelerator pedal
2005: Brake pedal
2006: Shift lever
2007: Front wheel
2008: Rear wheel
2009: Axle
2010: Electronic control unit
2012: Information service unit
2013: Communication module
2021: Current sensor
2022: Rotation speed sensor
2023: Pneumatic sensor
2024: Vehicle speed sensor
2025: Acceleration sensor
2026: Brake pedal sensor
2027: Shift lever sensor
2028: Object detection sensor
2029: Accelerator pedal sensor
2030: Driving support system unit
2031: Microprocessor
2032: Memory (ROM, RAM)
2033: Communication port (IO port)

1. A terminal that performs a communication with a base station via a satellite or a flying object, the terminal comprising:
a reception unit configured to receive from the base station, during the communication with the base station, information indicating a type of a non-terrestrial network; and
a control unit configured to perform a control based on the type of the non-terrestrial network.

2. The terminal according to claim 1, wherein the information indicating the type of the non-terrestrial network is an identifier indicating the type of the non-terrestrial network.

3. The terminal according to claim 1, wherein the control unit determines the type of the non-terrestrial network, based on the information received from the base station.

4. The terminal according to claim 1, wherein the control unit assumes, as a parameter related to a common timing advance, a value according to the type of the non-terrestrial network.

5. A communication method performed by a terminal that performs a communication with a base station via a satellite or a flying object, the communication method comprising:
receiving, from the base station during the communication with the base station, information indicating a type of a non-terrestrial network; and
performing a control based on the type of the non-terrestrial network.

6. The terminal according to claim 2, wherein the control unit assumes, as a parameter related to a common timing advance, a value according to the type of the non-terrestrial network.

7. The terminal according to claim 3, wherein the control unit assumes, as a parameter related to a common timing advance, a value according to the type of the non-terrestrial network.
